(19) United States
(12) Patent Application Publication
(10) Pub. No.: US 2009/0293301 A1
(43) Pub. Date: Dec. 3, 2009

(54) Device and Method for Drying Laundry

(75) Inventors: Thomas Koch, Berlin (DE); Ulrich Nehring, Berlin (DE); Kai Nitschmann, Neuenhagen (DE); Günter Steffens, Dallgow-Doberitz (DE); Andreas Stolze, Falkensee (DE); Henrik Volkers, Braunschweig (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munchen (DE)

(21) Appl. No.: 12/308,021

(22) PCT Filed: May 30, 2007
(86) PCT No.: PCT/EP2007/055219

§ 371 Date: Dec. 4, 2008

(30) Foreign Application Priority Data
Jun. 6, 2006 (DE) 10 2006 026 251.4

(51) Int. Cl. F26B 3/02; F26B 21/08; F26B 11/02

(52) U.S. Cl. 34/467; 34/80; 34/132

(57) ABSTRACT

A device and a method for drying laundry includes an essentially closed channel system for conveying a stream of air that acts on the laundry are a treatment chamber for loading the laundry, a blower to drive the airflow, a heater to heat the airstream before it strikes the laundry, and a cooler to cool the airstream after it strikes the laundry. The airstream flows through a heat pump in the channel system, encompassing a pump unit, a cold branch, and a warm branch, that are joined to each other in parallel and through which the appropriate parts of the airstream can flow in parallel.

The invention relates to a device for drying laundry, including an essentially closed channel system for conveying an airflow that acts on the laundry, in which channel system a treatment chamber for accommodating the laundry, a fan for driving the airflow, a heater for heating the airflow before it comes into contact with the laundry and a cooler for cooling the airflow after it has come into contact with the laundry are arranged.

The invention likewise relates to a method for drying laundry by means of an airflow conveyed in an essentially closed channel system, and acting on the laundry, in which channel system a treatment chamber for accommodating the laundry, a fan for driving the airflow, a heater for heating the airflow before it comes into contact with the laundry and a cooler for cooling the airflow after it comes into contact with the laundry are arranged.

Such a method and such a device are disclosed in each of the documents EP 0 477 554 B1 and EP 1 108 812 B1, the disclosure of which is to be fully assigned to the present disclosure. The channel system, in which the airflow is conveyed, is essentially closed, this means that the airflow during conventional operation essentially circulates without leakages, but does not adopt a significantly higher pressure than air in the surroundings of the device. The treatment chamber for accommodating the laundry is embodied as a rotatable drum.

EP 0 467 188 B1, the disclosure of which is to be fully assigned to the present disclosure, discloses a device for drying laundry, in which a heat pump is provided instead of the arrangement comprising the cooler and heater. In this way an evaporator takes the place of the cooler and a condenser for a working fluid which circulates in an associated circuit of the heat pump takes the place of the heater. The evaporator may be referred to as a “cold branch” of the heat pump, since it draws heat from the through-flowing airflow; similarly the condenser may be referred to as a “warm branch”, since it supplies heat to the through-flowing airflow. If necessary, the channel system, in which the airflow circulates, can be connected to the surroundings by opening a flap, in particular in order to discharge a part of the airflow, which is heated during operation, from the device and to replace it with relatively cool air from the surroundings.

DE 14 10 206 A discloses a washing machine, in which laundry can not only be washed but also dried. For the additional devices required for this purpose, the publication shows several alternatives; in particular an electrical heating device can be provided to heat an airflow used for drying laundry and a simple heat exchanger can be provided to cool the heated airflow after it acts on the laundry, alternatively, a heat pump may also be provided. This heat pump may be embodied like the heat pump disclosed in EP 0 467 188 B1, it can also be a heat pump which operates with Peltier elements in order to use the thermoelectric effect.

DE 19 738 735 C2 discloses a device for drying laundry of the type mentioned in the introduction, in which a heat pump is used, which operates according to an absorption principle.

A device disclosed in a short English extract pertinent to the data bank “Patent Abstracts of Japan” relating to JP 08 057 194 A for drying laundry, which corresponds in turn to the type described in the introduction, contains in its channel system, in addition to a thermoelectric heat pump with a cold and warm branch, an additional heat exchanger arranged upstream of the cold branch for cooling the airflow discharged by the laundry and an additional heating device arranged downstream of the warm branch for further heating the airflow before it acts on the laundry.

DE 35 09 549 A1 discloses a device for drying laundry, which in addition to a heat pump, has an additional heating device as well as additional heat transportation devices such as gravitational heat pipes.

It is common to all described devices of the prior art that their components required for drying the laundry are arranged in succession in the channel system provided for conveying the airflow. Such an arrangement places specific demands in terms of realization in a device which is suited and intended for use in a normal household. These demands may mean, as a result of a space which is only available to a limited degree, that components of the channel system are relatively small and must thus be embodied with a relatively high flow resistance for the airflow; this can significantly impair the effect of the drying process occurring in the device, since an airflow with a restricted volume throughput has to be driven in this way through a channel system which in some instances causes considerable frictional and throttling losses. This problem is particularly pronounced if a heat pump is used in the device, in particular a thermoelectric heat pump. In such a case, the channel system has to be folded repeatedly in a device, which is used in a domestic tumble dryer with conventional external dimensions.

Details relating to the basics, function and use of Peltier elements result from documents which were downloadable on Nov. 25, 2005 from the internet addresses http:///www.quick-ohm.de/waerme/download/Erlaeuterung-zu-Peltierelementen/pdf and http:///www.quick-ohm.de/waerme/download/Einbau.pdf.

One object, on which the present invention is based, is the development of the device cited in the introduction as well as the method cited in the introduction to the effect that the laundry can be dried by using an amount of energy which is reduced by comparison with the possibilities of the prior art.

This object can also be seen against the background of the use of a heat pump which is known from EP 0 467 188 B1 and further documents cited above. By default, the heat pump affords the recovery of at least part of the heat energy, which is fed to an airflow, before this acts on the laundry and extracts humidity and is then withdrawn from this airflow in order to condense humidity carried along therewith and extracted from the laundry and to remove it. A conventional heat pump for use in a tumble dryer is however comparatively complicated and expensive, whereby the use of a heat pump is restricted to markedly expensive tumble dryers. A conventional heat pump also requires a relatively large amount of time to achieve a stationary operating state after its start-up, so that laundry drying takes a relatively long time. The invention is to be used to solve these complex problems.

To solve the object, a device for drying laundry is specified in accordance with the invention, comprising an essentially closed channel system for conveying an airflow acting on the laundry, in which channel system a treatment chamber to accommodate the laundry, a fan for driving the airflow, a heater for heating the airflow before it acts on the laundry and a cooler for cooling the airflow after it acts on the laundry, are arranged, with a heat pump arranged in the channel system being provided, which includes a pump unit and a cold branch and a warm branch, with the cold branch and the warm branch being connected in parallel to one another and through which the appropriate parts of the airflow can flow in parallel.

Likewise to solve the object, a method is specified for drying laundry by means of an airflow conveyed in an essentially closed channel system and acting on the laundry, in which channel system a treatment chamber for accommodating the laundry, a fan for driving the airflow, a heater for heating the airflow before it acts on the laundry and a cooler for cooling the airflow after its acts on the laundry are arranged, with the airflow flowing through a heat pump including a pump unit as well as a cold branch and a warm branch, with the cold branch and the warm branch being traversed in parallel by corresponding parts of the airflow.

In accordance with the invention, a heat pump is thus provided in a device set up in the manner of a known circulating air tumble dryer, with which heat pump a part of the heat energy expended for heating the airflow can be recovered. From the knowledge that energy is always needed in a heat pump, in order to operate the desired pump process, the known arrangement made up of a conventional heater and a conventional cooler is not replaced in accordance with the invention simply by a heat pump but instead these components remain. They are to be set up such that they effect the drying of a kilogram of damp laundry from a conventional washing process within a maximum of 30 minutes. The additionally used heat pump is used to reduce the outlay of energy to such a degree that a given limit for the energy consumption, for instance a limit defined by the generally known energy consumption class A, is not exceeded. The heat pump is to be set up such that it reduces the energy consumption of the device per kilogram of used damp washing by at least 0.1 kWh, in particular approximately 0.13 kWh.

In accordance with the invention, a heat pump is used which differs significantly from the afore-described heat pumps. With this heat pump, heat is not withdrawn from and supplied to an airflow consecutively, with the airflow successively traversing corresponding components of the heat pump, but instead in two parts, into which the airflow is divided upstream of the heat pump. In accordance with the invention, a move away from a paradigm derived from a functional observation of the drying process is effected. The invention is thus developed largely advantageously in that the parallel arrangement of the cold and the warm branch renders an essentially double flow cross-section available with an essentially halved flow length for the airflow and thus significantly reduces a drop in pressure which occurs during the through-flow of the heat pump by comparison with any corresponding device of the prior art. The extent of this reduction is also especially great in that the cold and the warm branch of the heat pump no longer have to be successively traversed, in which case their respective flow resistances are added together. The use of the heat pump improves the performance of the dryer in terms of the pump power of the Peltier elements, which currently lies between 50% and 70% of their electrical power input. In the case of an electrical power input of 500 W (see also below), a power input between 250 W and 350 W is accordingly to be expected.

The channel system in the device downstream of the cooler preferably includes a separator for separating humidity from of the airflow. This separator allows humidity, which was condensed out of the airflow in the cooler or in the cold branch of the heat pump, to be removed from the airflow and fed to a suitable collection container.

The treatment chamber of the device is preferably rotatable and in particular embodied as a drum for accommodating the laundry, with the drum being provided internally with ridged agitator paddles. In such a drum, the laundry can be moved and tumbled in the airflow acting thereupon, which is necessary in order to uniformly dehumidify the laundry by significantly avoiding wrinkling in the laundry.

It is particularly preferred that the heater and cooler are set up in order to dry the laundry without using the heat pump. In particular, in this context the heater is preferably set up for a maximum heating power of at most 2700 W, in particular approximately 2000 W. Accordingly, the cooler is designed in particular for a cooling power of at least 1000 W, in particular approximately 1800 W. This and the subsequent power ratings apply in particular to a device, which is set up to dry 7 Kg of damp washing from a conventional washing process.

The heat pump is preferably designed for a power output between 200 W and 800 W, in particular approximately 500 W. In this design, the heat pump can reduce the energy consumption of a conventional tumble dryer of the energy efficiency class C to such a degree that the dryer augmented by this heat pump can be assigned to the energy efficiency class A. In this way the pump power of the heat pump amounts in particular to between 200 W and 300 W, with the pump power corresponding to that power, with which heat energy is pumped from the cold branch to the warm branch of the heat pump.

The pump unit of the heat pump is preferably a thermo-electrical pump unit, in other words a pump unit which functions with Peltier elements as functional components. In this context, the pump unit preferably has a power output of approximately 500 W; the heater is set up for the optional operation at a higher level with a power output of approximately 2000 W and at a lower level with a power output of approximately 500 W, with in particular the heater and the pump unit being set up for control purposes such that the pump unit is operated together with the heater. The heater contains in the simplest instance a preferably electrically operable heating element; in order to be able to adjust its heating power in a flexible fashion to the requirements of the drying process, it is possibly advantageous for the heater to have two or more heating elements or heating stages.

One configuration according to the previous paragraph is shown in particular such that the heater contains two heating elements which can be operated independently of one another, the first of which is connected in series with the heat pump together with an associated switch or relay and the second of which is connected in parallel to this series circuit together with an associated switch or relay. It is particularly possible to use the full power output of the heater and the heat pump in order to rapidly heat the device following on from its start-up and thus to create a prerequisite for an effective drying process of the laundry within the scope of a largely almost stationary operation. If the device is heated sufficiently, the power output of the heater can be reduced if necessary, with the further operating heat pump partially compensating for the reduced power of the heater in any case and also improving the dehumidification of the airflow flowing from the treatment chamber and saturated with humidity.

The device in the channel system upstream of the heat pump preferably contains a first divider, by means of which the airflow can be separated into a first part conveyed by the cold branch and a second part conveyed by the warm branch, with the first part being between approximately 20% and approximately 50%, in particular between 25% and 50% of the entire airflow. This corresponds to a division which is particularly well matched to the service requirements.

The heat pump is also preferably arranged in the airflow between the cooler and the heater. In this way, the channel system also preferably contains a second divider upstream of the cooler, by means of which the airflow can be divided into a third part conveyed by the cooler and a fourth part conveyed by a auxiliary channel connected in parallel to the cooler. This results in an additional energy saving, since instead of the overall airflow, only the third part reaches the cooler and only this energy is withdrawn. It is particularly preferred for the auxiliary channel also to be connected in parallel to the heat pump, or alternatively the auxiliary channel to open into a first branch of the heat pump, preferably the cold branch, and a second branch of the heat pump, preferably the warm branch, to be connected to the cooler.

A preferred embodiment of the inventive method lies in the heat pump being operated during the drying process for a period of 65% to 95% of a duration of the drying process. The heat pump is further preferably out of operation, if a residual humidity between 15% and 5%, in particular approximately 7%, is reached in the laundry.

Exemplary embodiments of the invention are explained in more detail below with reference to the drawing. The Figures of the drawing show topologies of tumble dryers and are in no way to be understood as accurate scale reproductions of real objects.

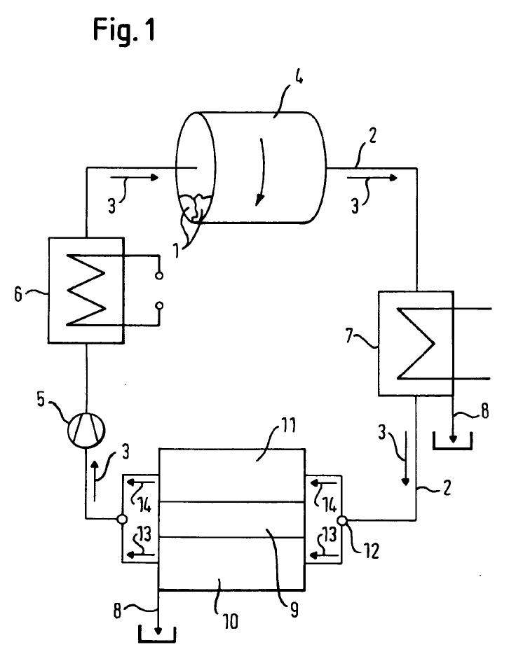

FIG. 1 shows a detailed exemplary embodiment of a device for drying laundry with a thermoelectric heat pump;

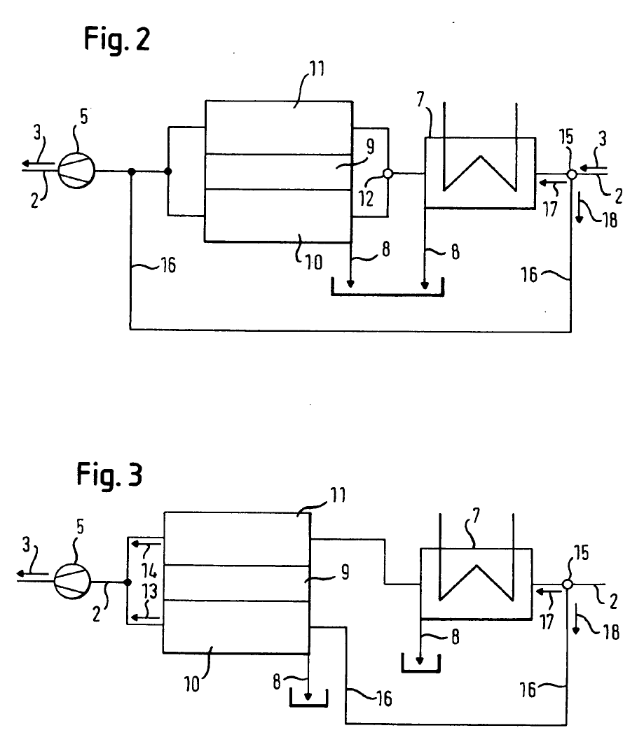

FIGS. 2, 3, 4 and 5 each show a detailed exemplary embodiment of a development of the device according to FIG. 1 and

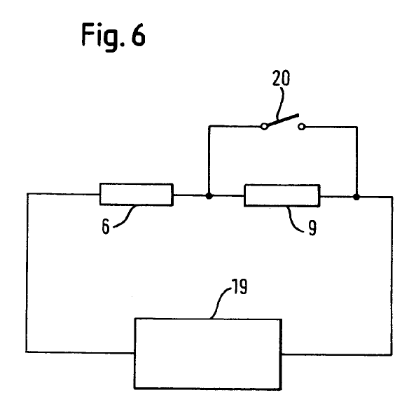

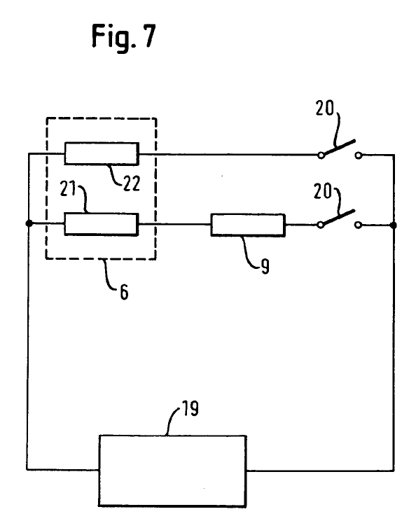

FIGS. 6 and 7 show a detailed circuit diagram relating to the supply of a heater and a heat pump with electrical energy.

FIG. 1 shows a device for drying laundry 1, which has an essentially closed channel system 2 for conveying an airflow 3 which acts on the laundry 1. In the channel systems 2 are arranged a treatment chamber 4 for accommodating the laundry 1, a fan 5 for driving the airflow 3, a heater 6 for heating the airflow 3 before it acts on the laundry 1 and a cooler 7 for cooling the airflow 3 after it acts on the laundry 1. The airflow 3 is shown by means of arrows, which are drawn in the Figure in addition to the channel system 2, and each specify the direction of the airflow 3 circulating in the channel system 2. The airflow 3 circulates without significantly replacing air from the surroundings of the device, with a significant pressure difference in respect of the surroundings not occurring at any point within the device. For this reason, the channel system 2 is currently referred to as “essentially closed”.

It is firstly to be noted that the heater 6 and cooler 7 are set up such that they are suited, without that use of additional previously undetailed components in the channel system 2, to drying the laundry 1 within a normal time frame for a conventional domestic tumble dryer. To this end, the heater 6 and the cooler 7 have specific performance values, which were mentioned above and to which reference is made.

The treatment chamber 4 is embodied in accordance with conventional practice as a rotatable drum 4; its rotation moves the laundry 1 in the airflow 3, which assists with a uniform absorption of humidity in the airflow 3. In the cooler 7, the humidity carried along by the airflow 3 from the drum 4 is condensed out and is separated from the airflow 3 by means of a separator 8.

The device in FIG. 1 is characterized by a heat pump 9, 10, 11 arranged in the channel system 2 including a thermoelectric pump unit 9 as well as two heat exchangers 10 and 11, one of which, the “cold branch” 10, is used to cool through-flowing air and the other of which, the “warm branch” 11, is used to heat through-flowing air. The pump unit 9 contains semiconductor components as functionally important components, which produce temperature differences when using the Peltier effect if they are flowed through by an electrical current. Such Peltier elements are known per se and currently do not require any further explanation in addition to a notification in respect of the afore-cited documents relating to the pertinent prior art.

The heat pump 9, 10, 11 is embodied differently to a widespread paradigm such that the airflow 3 does not flow through its cold branch 10 and its warm branch 11 successively, but instead in parallel. To this end, the airflow 3 at a first divider 12 is separated into a first part 13, which flows through the cold branch 10 and a second part 14, which flows through the warm branch 11. The two parts 13 and 14 are joined again behind the heat pump 9, 10, 11 to form the airflow 3 and reach the drum 4 by way of the fan 5 and the heater 6. It is natural that the cold branch 10 has a separator 8, in order to separate condensed humidity from the first part 13. It is also clear that the separator 8 of the cooler 7 and of the cold branch 10 interact expediently as far as possible.

The heat pumps 9, 10, 11 assist with the action of the cooler 7 on the one hand by additionally separating humidity from the airflow 3 and/or the first part 13 and likewise the action of the heater 6 on the basis of the additional heating of the airflow 3 and/or the second part 14 taking place in the warm branch 11. To this end, energy is only supplied to the extent necessary to operate the pump unit 9 and the thermal power of the heater 6 can in particular be reduced. There is thus a clear saving of energy of an amount, which is sufficient in any case to assign the device to the energy efficiency class A. The device does not have the disadvantages of a conventional home appliance tumble dryer with a heat pump; it is in particular possible to bring the device relatively quickly to its operating temperature and the heat pump 9, 10, 11 can be switched off towards the end of the drying process, if only very little humidity can still be condensed out of the airflow.

FIG. 2 shows a development of the device according to FIG. 1. With this development, a second divider 15 is provided in the channel system 2 upstream of the cooler 7, from which divider branches off an auxiliary channel 16. Only a third part 17 of the airflow 3 reaches the cooler 7 and the heat pump 9, 10, 11, and a fourth part 18 of the airflow passes through the auxiliary channel 16 around the cooler 7 and the heat pump 9, 10, 11 until it reaches the fan 5, where it is reunited with the third part 17. This embodiment results in further energy savings, since it is no longer necessary to cool the complete airflow 3 to such a degree than the desired condensation of contained humidity can take place. The condensation instead occurs exclusively from the third part 17. Incidentally, FIG. 2 also shows the interaction of the separator 8 of the cooler 7 and/or of the cold branch 10.

A particularly preferred embodiment can be seen in FIG. 3. A second divider 15 is in turn located in the channel system 2 upstream of the cooler 7, from which a fourth part 18 of the airflow 3 is conveyed in an auxiliary channel 16. This auxiliary channel 16 passes the cooler 7 directly to the cold branch 10 of the heat pump 9, 10, 11. A third part 17 of the airflow 3 passes through the cooler 7 and from there to the warm branch 11 of the heat pump 9, 10, 11. With this embodiment, humidity from the whole airflow 3 is condensed, with the distribution of this condensation to the cooler 7 and the cold branch 10 being a matter of the rating of the performance values of these components.

In any case, the particularly minimal flow resistance of the special heat pumps 9, 10, 11 employed is used in order to discharge the conventional heater 6 and the conventional cooler 7 and to render the energy, which is lost without using the heat pump 9, 10, 11, usable for drying the laundry 1. Preferred performance values for the components claimed just now are cited above and reference is made here to these specifications.

FIG. 4 shows a different development of the device according to FIG. 1. Contrary to the development according to FIG. 3, the auxiliary channel 16 leads from the second branch 15 to the warm branch 11 of the heat pump 9, 10, 11 and the second branch 10 follows the cooler 7.

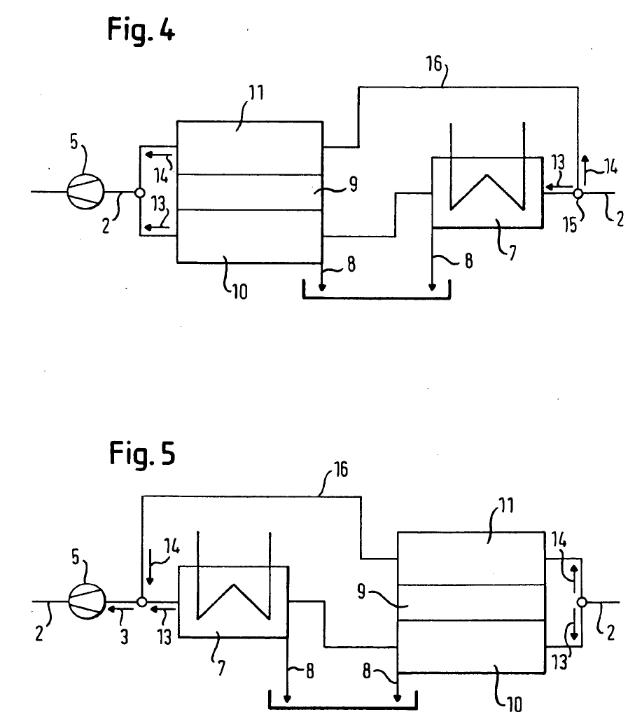

Another development of the device according to claim 1 is found in FIG. 5, with this development essentially differing from the development according to FIG. 4 in that the arrangement including the heat pump 9, 10, 11, the heater 6 and the auxiliary channel 16, is identical in structure, but is traversed in the opposite direction by the airflow 3 or its parts 12 and 13. This has a functionally very minimal influence; it clarifies that the present teaching is not restricted to a certain series of components of the device in the airflow 3.

With the development according to FIG. 4 and FIG. 5, condensation only appears from the first part 13 of the airflow 3, which is certainly advantageous in that only this first part 13 has to be cooled to such a degree that condensation can take place and as a result, a reduction in the energy to be withdrawn necessarily from the airflow 3 is achieved.

FIG. 6 shows a circuit diagram of the electrical power supply of the heater 6 and the pump unit 9. As cited further above, it is advantageous to operate the heater 6 without operating the pump unit 9 with approximately four times the electrical power than during the operation of the pump unit 9. To this end, it is advantageous to embody the heater 6 and the pump unit 9 with the same ferrule resistors, as shown in FIG. 4 to connect said heater and pump unit electrically in series and to connect the same to a single power supply 19. A switch 20 is also provided, with which the pump unit 9 is bridged, if it is not to operate. If the heater 6 and the pump unit 9 are operated together, half of the initial voltage of the energy supply 19 is present over each of these components 6, 9 and current flows, which is half as great as when only the heater 6 was supplied in the case of a closed switch 20. Accordingly, the power of the individually operated heater 6 is desirably four times as great as the power of the heater 6, if the pump unit 9 is operated simultaneously in the case of an open switch 20.

In the circuit according to FIG. 7, the heater 6 is embodied with two electrical heater elements 21 and 22 which can be operated independently of one another. The first heater element 21 is connected in series with the pump unit 9 in addition to an associated switch (or relay) 20 which is arranged upstream thereof. The second heater element 22 is connected in parallel to this series arrangement in addition to the associated switch (or relay) 20 which is arranged upstream thereof. This circuit arrangement manages with two switches or relays 20, in order to operate the heater 6 and the pump arrangement 9 together, either with the first heater element 21 only or with both the heater elements 21 and 22. It also enables the necessary direct voltage to be generated in the energy supply 19 by simply directing the mains supply voltage of particularly 230 V and to manage without the use of a buck converter or suchlike. The corresponding selection of the first heater element 21 by considering the inner switching structure of the pump unit 9 allows the compatibility of the series arrangement to be produced with such a direct voltage and the desired performance of the heater 6 to be produced by suitably selecting the second heater element 22.

### LIST OF REFERENCE CHARACTERS

1. Laundry

2. Channel system

3. Airflow

4. Treatment chamber, drum

5. Fan

6. Heater

7. Cooler

8. Separator

9. Heat pump, pump unit

10. Heat pump, cold branch

11. Heat pump, warm branch

12. First divider

13. First part of the airflow

14. Second part of the airflow

15. Second divider

16. Auxiliary channel

17. Third part of the airflow

18. Fourth part of the airflow

19. Power supply

20. Switch or relay

21. First heater element

22. Second heater element

1-18. (canceled)

19. A device for drying laundry including an essentially closed channel system for conveying an airflow acting on a washing, the channel system of the device comprising:
a treatment chamber for receiving the laundry;
a fan for driving the airflow;
a heater for heating the airflow before it acts on the laundry;
a cooler for cooling the airflow after it acts on the laundry; and
a heat pump comprising a pump unit, a cold branch, and a warm branch, connected parallel to one another and through which corresponding parts of the airflow can flow in parallel.

20. The device of claim 19, wherein the channel system comprises a separator downstream of the cooler for separating moisture from the airflow.

21. The device of claim 19, wherein the treatment chamber comprises a rotatable drum.

22. The device of claim 1, wherein the heater and the cooler can dry the laundry without using the heat pump.

23. The device of claim 1, wherein the heater has a maximum heating power of at most 2700 W.

24. The device of claim 1, wherein the cooler has a cooling power of at least 1000 W.

25. The device of claim 1, wherein the heat pump has a power output of between 200 W and 800 W.

26. The device of claim 1, wherein the pump unit comprises a thermoelectric pump unit.

27. The device of claim 26, wherein the pump unit has a power output of approximately 500 W, and the heater is set up to optionally operate at a high level with a power output of approximately 2000 W and at a lower level with a power output of approximately 500 W, with the heater and the pump unit being set up for control purposes such that the pump unit is operated together with the heater.

28. The device of claim 27, wherein the heater has two heater elements which are operable independently of one another, the first of which is connected in series with the heat pump and an associated switch, and the second of which is connected in parallel to this series circuit and the associated switch.

29. The device of claim 1, wherein the heat pump is between the cooler and the heater.

30. The device of claim 1, wherein the channel system comprises a first divider upstream of the heat pump unit that divides an airflow into a first part conveyed through the cold branch and a second part conveyed through the warm branch, with the first part amounting to between approximately 20% and approximately 50%.

31. The device of claim 30, wherein the channel system comprises a second divider upstream of the cooler that divides the airflow into a third part through the cooler and a fourth part through an auxiliary channel which is connected in parallel to the cooler.

32. The device of claim 31, wherein the auxiliary channel is also connected in parallel to the heat pump.

33. The device of claim 31, wherein the auxiliary channel opens into a cold branch of the heat pump and a warm branch of the heat pump and is connected to the cooler.

34. The device of claim 1, wherein the heater has a heating power of approximately 2000 W, the cooler has a cooling power of approximately 1500 W, and the heat pump has a power output of approximately 500 W.

35. A method for drying laundry comprising:
driving an airflow with a fan in a closed channel system;
heating the airflow with a heater in the closed channel system;
flowing the airflow through a heat pump in the closed channel system, the heat pump having a pump unit, a cold branch, and a warm branch that is parallel to the cold branch;
drying the laundry with the airflow in a treatment chamber accommodating the laundry in the closed channel system; and
cooling the airflow with a cooler in the closed channel system after drying the laundry.

36. The method of claim 35, further comprising operating the heat pump during about 65% to 95% of the duration of the drying of the laundry.

37. The method of claim 36, further comprising ceasing operation of the heat pump if a residual humidity of between 15% and 5% is reached in the laundry.

38. The method of claim 36, further comprising ceasing operation of the heat pump if a residual humidity of 7% is reached in the laundry.
